(19) United States
(12) Patent Application Publication
(10) Pub. No.: US 2016/0239239 A1
(43) Pub. Date: Aug. 18, 2016

(54) Storage Method and Software Defined Storage System

(71) Applicant: Wistron Corporation, New Taipei City (TW)

(72) Inventors: Hsiao-Wen Tin, New Taipei City (TW); Chih-Ming Chen, New Taipei City (TW)

(21) Appl. No.: 14/748,196

(22) Filed: Jun. 23, 2015

(30) Foreign Application Priority Data
Feb. 17, 2015 (TW) 104105688

(51) Int. Cl. G06F 3/06

(52) U.S. Cl. CPC G06F 3/0647; G06F 3/0608; G06F 3/0664; G06F 3/0674

(57) ABSTRACT

A storage method utilized in a software defined storage (SDS) system is disclosed. The SDS system includes a load balancer, a control unit and a plurality of adaptor units. The plurality of adaptor units corresponds to a plurality of virtual targets. The storage method includes the load balancer sending a command to the plurality of adaptor units after the SDS system receives the command; the control unit generating a matching information according to characteristics of the plurality of virtual targets, and sending the matching information to the plurality of adaptor units; and a first adaptor unit of the plurality of adaptor units forwarding the command to the first virtual target according to the matching information and the command, and the SDS system performing operation on a first virtual target.

### BACKGROUND OF THE INVENTION

1. Field of the Invention

The present invention relates to a storage method and a software defined storage system, and more particularly, to a storage method and a software defined storage system with low production cost.

2. Description of the Prior Art

Facing an age of Big Data, a capacity required by a storage device is getting larger. Traditionally, extending storage devices for storage systems requires a couple of weeks, which is time consuming. In addition, compatibility problems between storage devices with various brands need to be solved. Software defined storage systems may detach the storage management functions from the physical storage device, and leave external software to perform the storage management functions. The storage management functions may be setting of a redundant array of independent disks (RAID) level, data volume management, data protection, data replication, information snapshot, etc. Therefore, extending the storage devices for the storage systems only takes few hours. The storage management functions executed by the external software may avoid the compatibility problems between the storage devices with various brands.

FIG. 1 is a schematic diagram of a software defined storage (SDS) system 10 in the prior art. The SDS system 10 comprises a load balancer 100 and adaptors 102_1-102_N. The load balancer 100 is utilized for sending a command to the adaptors 102_1-102_N after receiving the command from a client. The adaptors 102_1-102_N are storage interface cards, which are utilized for performing operations on data stored by the SDS system 10. Moreover, the command from the client comprises a target information, for instructing the SDS system 10 to perform operations such as read, write, etc., on a target data corresponding to the target information. Each adaptor may forward the command to a virtual target corresponding to the target information, and the SDS system 10 may perform operations on the target data to which the command refers. The virtual target may be duplicated as a plurality of replicas by a mirroring operation. The plurality of replicas are utilized for shortening the response time. When one replica is busy such that the response time is too long, the adaptor may choose another replica, to reduce the response time for accessing the target data. Take FIG. 1 as an example, a virtual target vTGT_b has 3 replicas after the mirroring operation, and virtual targets vTGT_1, vTGT_M only have one replica. In addition, each replica may correspond to a virtual disk vDSK, i.e., a logic unit number (LUN). The virtual disk vDSK may correspond to a virtual volume vVOL. The SDS system 10 may perform operations on target data to which the virtual volume vVOL refers.

In order to perform storage control (e.g., select a replica with shortest path or response time among the plurality of replicas), the adaptors 102_1-102_N comprise control units 104_1-104_N, respectively. The control units 104_1-104_N are utilized for executing the storage control and related computations (e.g., the computation involving path selection to finding the shortest path for the adaptors 102_1-102_N). Thus, the control units 104_1-104_N need a certain level of computation capability, such that the production cost of the adaptors 102_1-102_N is extremely expensive. When the SDS system 10 comprises more adaptors, the cost of the SDS system 10 increases as well. Therefore, how to reduce the production cost of SDS system is a significant objective in the field.

### SUMMARY OF THE INVENTION

It is therefore a primary objective of the present invention to provide a storage method and a software defined storage system with low production cost.

An embodiment of the invention discloses a storage method utilized in a software defined storage (SDS) system, the SDS system comprising a load balancer, a control unit and a plurality of adaptor units, the plurality of adaptor units corresponding to a plurality of virtual targets, the storage method comprising the load balancer sending a command to the plurality of adaptor units after the SDS system receives the command; the control unit generating a matching information according to characteristics of the plurality of virtual targets, and sending the matching information to the plurality of adaptor units; and a first adaptor unit of the plurality of adaptor units forwarding the command to the first virtual target according to the matching information and the command, and the SDS system performing operation on a first virtual target.

An embodiment of the invention further discloses a software defined storage system, comprising a plurality of adaptor units corresponding to a plurality of virtual targets; a load balancer configured to send a command to the plurality of adaptor units; and a control unit configured to generate a matching information according to characteristics of the plurality of virtual targets, and send the matching information to the plurality of adaptor units; wherein a first adaptor unit of the plurality of adaptor units forwards the command to the first virtual target according to the matching information and the command, and the SDS system performs operation on a first virtual target.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a software defined storage (SDS) system in the prior art.

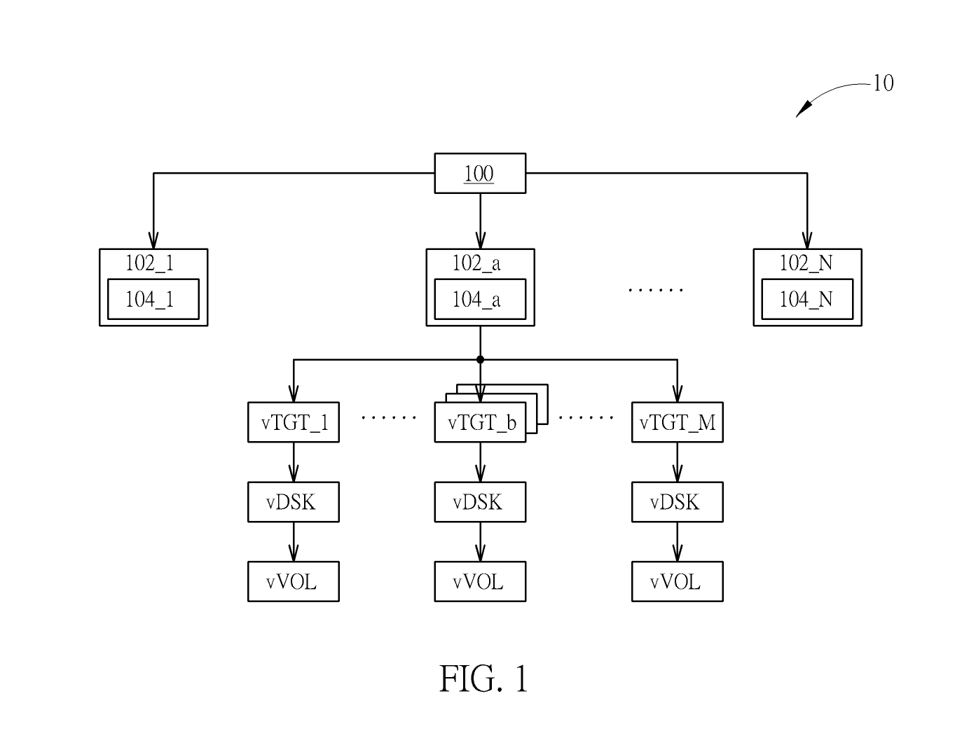

FIG. 2 is a schematic diagram of a SDS system according to an embodiment of the invention.

FIG. 3 is a schematic diagram of a storage process according to an embodiment of the invention.

FIG. 4 is a schematic diagram of a plurality of target duplicates according to an embodiment of the invention.

FIG. 5 is a flowchart of an ant colony optimal (ACO) algorithm.

### DETAILED DESCRIPTION

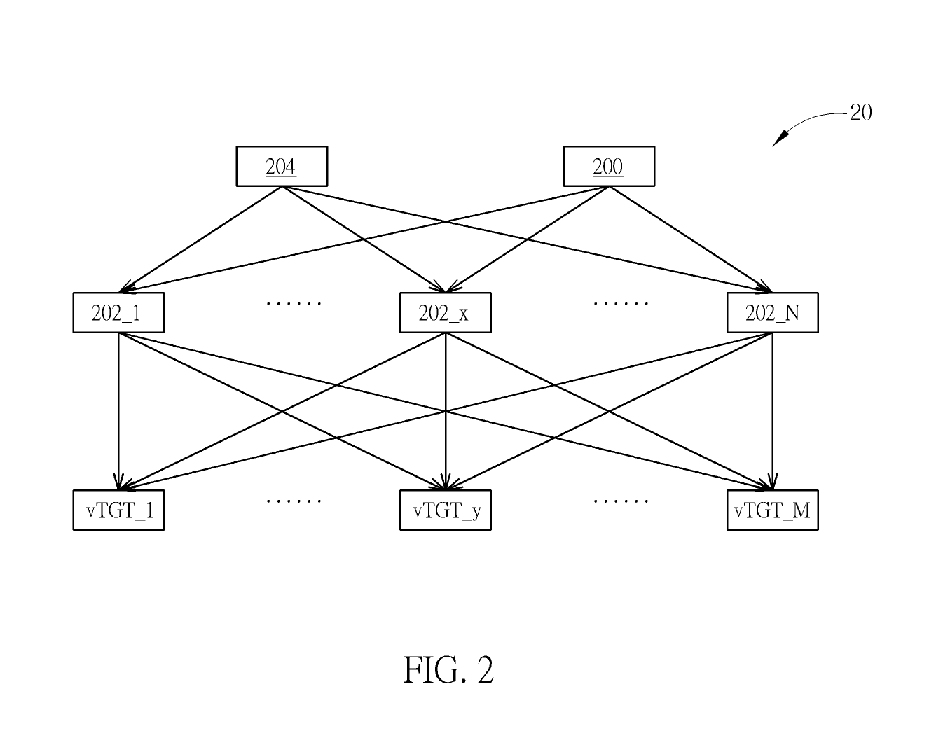

Please refer to FIG. 2, which is a schematic diagram of a software defined storage (SDS) system 20 according to an embodiment of the invention. The SDS system 20 may receive a command CMD from a client terminal, and perform operations according to the command CMD. The SDS system 20 comprises a load balancer 200, adaptor units 202_1-202_N and a control unit 204. The load balancer 200 sends the command CMD to the adaptor units 202_1-202_N. The command CMD is a small computer system interface (SCSI) command, which comprises target information, for instructing the SDS system 20 to perform operations such as read, write, etc., on target data corresponding to the target information. The target information is corresponding to a virtual target vTGT_y among virtual targets vTGT_1-vTGT_M of the SDS system 20. The adaptor units 202_1-202_N may forward the command CMD to the virtual targets vTGT_1-vTGT_M. Moreover, the virtual targets vTGT_1-vTGT_M are implemented via software. The control unit 204 is utilized for determining matching relationships between the adaptor units 202_1-202_N and the virtual targets vTGT_1-vTGT_M. Specifically, the control unit 204 may generate a matching information table TBE according to characteristics of the virtual targets vTGT_1-vTGT_M, and send the matching information table TBE to the adaptor units 202_1-202_N. After an adaptor unit 202_x of the adaptor units 202_1-202_N receives the matching information table TBE, the adaptor unit 202_x may forward the command CMD to the virtual target vTGT_y according to the matching information table TBE. Thus, the SDS system 20 may perform operations on the target data to which the command CMD refers. Furthermore, the control unit 204 generates the matching information table TBE according to response times of the virtual targets vTGT_1-vTGT_M in relation to the adaptor units 202_1-202_N. In addition, the control unit 204 may be implemented by hardware equipment with a certain level of computation capability, such as computer, server, etc.

In short, in the SDS system 20, computation of path selection are centralized and executed by the control unit 204. The control unit 204 may represent the computational results of path selection in a form of the matching information table TBE, and send the matching information table TBE to the adaptor units 202_1-202_N. Thus, there is no need for the adaptor units 202_1-202_N to execute computation of path selection. All the adaptor units 202_1-202_N have to do is to receive the matching information table TBE from the control unit 204, and forward the command CMD to the corresponding virtual target according to the matching information table TBE. Therefore, the adaptor units 202_1-202_N may be implemented by cheap storage interface cards, so as to reduce the production cost of the SDS system 20.

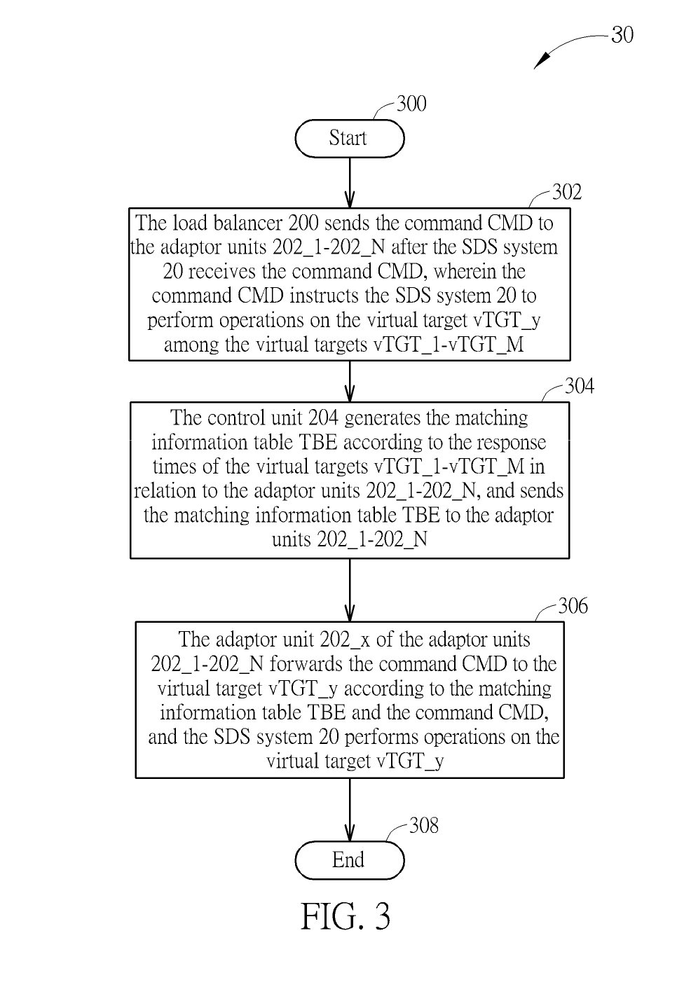

The process of the SDS system 20 receiving the command CMD and performing operations on the virtual target to which the command CMD refers is illustrated in FIG. 3, which is a schematic diagram of a storage process 30 according to an embodiment of the invention. As shown in FIG. 3, the storage process 30 comprises following steps:

Step 300: Start.

Step 302: The load balancer 200 sends the command CMD to the adaptor units 202_1-202_N after the SDS system 20 receives the command CMD, wherein the command CMD instructs the SDS system 20 to perform operations on the virtual target vTGT_y among the virtual targets vTGT_1-vTGT_M.

Step 304: The control unit 204 generates the matching information table TBE according to the response times of the virtual targets vTGT_1-vTGT_M in relation to the adaptor units 202_1-202_N, and sends the matching information table TBE to the adaptor units 202_1-202_N.

Step 306: The adaptor unit 202_x of the adaptor units 202_1-202_N forwards the command CMD to the virtual target vTGT_y according to the matching information table TBE and the command CMD, and the SDS system 20 performs operations on the virtual target vTGT_y.

Step 308: End.

In Step 302, the load balancer 200 sends the command CMD to the adaptor units 202_1-202_N. The adaptor units 202_1-202_N may perform operations on the virtual targets vTGT_1-vTGT_M. The command CMD instructs the SDS system 20 to perform operations on the virtual target vTGT_y.

In Step 304, the control unit 204 generates the matching information table TBE according to the response times of the virtual targets vTGT_1-vTGT_M in relation to the adaptor units 202_1-202_N, and sends the matching information table TBE to the adaptor units 202_1-202_N. In other words, the computation executed by the control unit 204 is to find one of the virtual targets vTGT_1-vTGT_M with the shortest path, i.e., to find a virtual target with the shortest response time among the virtual targets vTGT_1-vTGT_M, and record the shortest path results as the matching relationships between the adaptor units 202_1-202_N and the virtual targets vTGT_1-vTGT_M as the matching information table TBE. TABLE I illustrates an exemplary format of the matching information table TBE. TABLE I comprises an adaptor unit column, a virtual target column and a SCSI command column. As TABLE I shown, the adaptor unit column is filled with the adaptor units 202_1-202_N, and the virtual target column is filled with the virtual targets vTGT_1-vTGT_M corresponding to the adaptor units 202_1-202_N. For example, according to TABLE I, a virtual target vTGT_k1 referred by a command CMD_1 is corresponding to the adaptor unit 202_1, a virtual target vTGT_kN referred by a command CMD_N is corresponding to the adaptor unit 202_N, and the virtual target vTGT_y referred by the command CMD is corresponding to the adaptor unit 202_x.

TABLE I

| Adaptor Unit | Virtual Target | SCSI Command |
|---|---|---|
| Adaptor Unit 202_1 | Virtual Target vTGT_k1 | Command CMD_1 |
| . | . | . |
| . | . | . |
| . | . | . |
| Adaptor Unit 202_x | Virtual Target vTGT_y | Command CMD |
| . | . | . |
| . | . | . |
| . | . | . |
| Adaptor Unit 202_N | Virtual Target vTGT_kN | Command CMD_N |

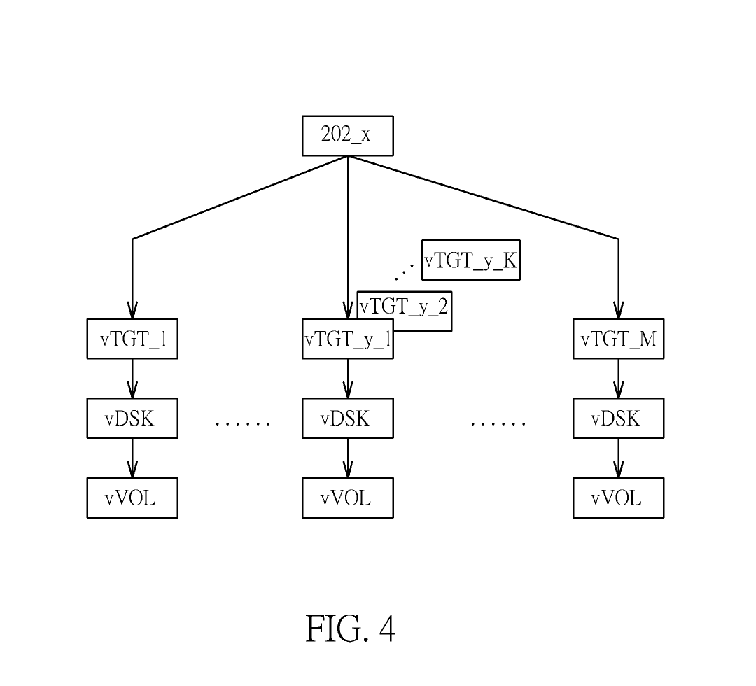

In another perspective, to achieve shorter response time of the virtual targets, a path-diversity between an adaptor unit and a virtual target may be enhanced by duplicating replicas of the virtual targets. Specifically, the virtual target may optionally be duplicated as a plurality of replicas by a mirroring operation. When one replica is busy such that the response time is too long, the adaptor may forward the command CMD to another replica, to reduce the response time for accessing the target data, wherein the virtual targets may be implemented by software. For example, in an embodiment, the virtual target vTGT_y may be duplicated as replicas vTGT_y_1-vTGT_y_K by mirroring, as shown in FIG. 4. In addition, a number of the replicas is adjustable depending on system requirements. For example, when the response time of the virtual target vTGT_y is greater than a first value, the SDS system 20 may increase the number of the replicas corresponding to the virtual target vTGT_y. When the response time of the virtual target vTGT_y is smaller than a second value, the SDS system 20 may decrease the number of the replicas corresponding to the virtual target vTGT_y. Furthermore, each replica may correspond to a virtual disk vDSK, i.e., a logic unit number (LUN). The virtual disk vDSK may correspond to a virtual volume vVOL. The SDS system 20 may perform operations on target data to which the virtual volume vVOL refers.

In such a situation, the control unit 204 selects an optimum replica vTGT_y_opt (with the shortest path/response time) among the replicas vTGT_y_1-vTGT_y_K according to the inter-relationship of the adaptor units 202_1-202_N and the replicas vTGT_y_1-vTGT_y_K. Specifically, the control unit 204 may employ an ant colony optimal (ACO) algorithm to select the optimum replica vTGT_y_opt with the shortest response time among the replicas vTGT_y_1-vTGT_y_K. The ACO algorithm is a probabilistic algorithm which simulates pheromone left by ants on the paths, which would converge to an optimum path through multiple iterations. Using ACO to find the optimum path is known by the art, which is narrated briefly as follows.

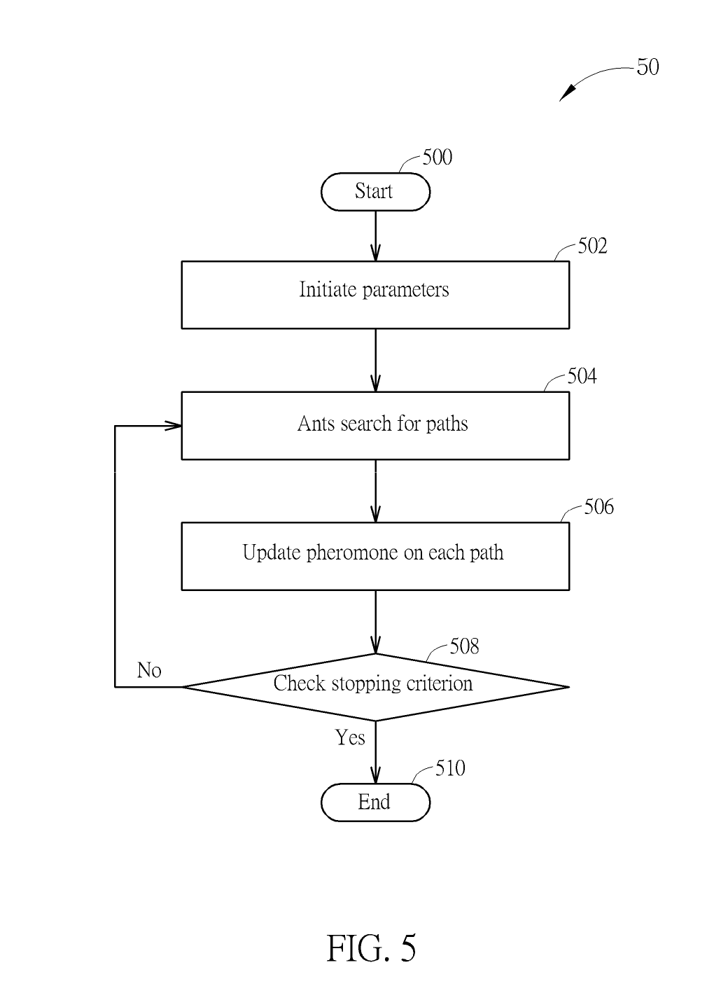

FIG. 5 is a flow chart of an ACO process 50. As shown in FIG. 5, the ACO process 50 comprises following steps:

Step 500: Start.

Step 502: Initiate parameters.

Step 504: Ants search for paths.

Step 506: Update pheromone on each path.

Step 508: Check a stopping criterion. If yes, go to Step 510; otherwise, go to Step 504.

Step 510: End.

In Step 502, all the parameters required by the ACO algorithm are initiated, including an influence parameter α, an influence of initial pheromone β, a pheromone evaporation coefficient δ, a constant Q affecting pheromone and a number of ants R. In Step 504, the ants searching for the paths are simulated, and the path selection probability is calculated. Specifically, the probability for the r-th ant starting from the i-th node to the j-th node at the t-th iteration may be expressed as

$${p}_{ij}^{r} ( t ) = \{ \begin{matrix}\frac{{( {τ}_{ij} ( t ) )}^{α} \times {( {η}_{ij} )}^{β}}{{\sum }_{u ∈ {J}_{k} ( i )} {( {τ}_{iu} ( t ) )}^{α} \times {( {η}_{iu} )}^{β}} , & j ∈ {J}_{r} ( i ) \\ 0 , & otherwise\end{matrix} ; \qquad ( eqn . 1 )$$

wherein τᵢⱼ(t) represents an amount of pheromone deposited on the path from the i-th node to the j-th node, ηᵢⱼ represents an initial pheromone deposited on the path from the i-th node to the j-th node, which usually is an inverse of a distance between the i-th node to the j-th node, and Jᵣ(i) represents a set of nodes which have not been passed by the r-th ant. When the r-th ant stands at the i-th node determining the next node the r-th ant likes to proceed, the larger the value of (τᵢⱼ(t)^{α}×(ηᵢⱼ)^{β}, the larger probability for the r-th ant to select the j-th node. After all the ants select all the nodes, in Step 506, pheromone on each path is updated as follows:

$$\begin{matrix}{τ}_{ij} ( t ) = ( 1 - δ ) \times {τ}_{ij} ( t ) + {\sum }_{r = 1}^{R} Δ {τ}_{ij}^{r} & ( eqn . 2 ) \\ Δ {τ}_{ij}^{r} = \{ \begin{matrix}\frac{Q}{{L}_{r}} , & \begin{matrix}if the r \text{-} th ant starts from the \\ i \text{-} th node to the j \text{-} th node\end{matrix} \\ 0 , & otherwise\end{matrix} ; & ( eqn . 3 )\end{matrix}$$

wherein Lᵣ is the a total length traveled by the r-th ant. One iteration represents that pheromone of all of the paths is updated once. In Step 508, the stopping criterion is checked. The stopping criterion is a difference between a solution obtained at the T-th iteration and a solution obtained at the (T−1)-th iteration being smaller than a specific value, or a number of iterations is achieved to a predetermine number. When the stopping criterion is achieved, the ACO process 50 is terminated.

Notably, the distance between the nodes in the ACO algorithm represents the response time the between nodes. The nodes herein represent the adaptor units 202_1-202_N, the virtual targets vTGT_1-vTGT_M and the replicas thereof in the SDS system 20. According to the ACO, the control unit 204 may select the optimum replica vTGT_y_opt with the shortest response time among the replicas vTGT_y_1-vTGT_y_K. In such a situation, the matching information table TBE generated by the control unit 204 should contain information of the optimum replica vTGT_y_opt. As shown in TABLE II, the command CMD is corresponding to the optimum replica vTGT_y_opt.

TABLE II

| Adaptor Unit | Virtual Target | SCSI Command |
|---|---|---|
| Adaptor Unit 202_1 | Virtual Target vTGT_k1 | Command CMD_1 |
| . | . | . |
| . | . | . |
| . | . | . |
| Adaptor Unit 202_x | Optimum Replica | Command CMD |
| | vTGT_y_opt | |
| . | . | . |
| . | . | . |
| . | . | . |
| Adaptor Unit 202_N | Virtual Target vTGT_kN | Command CMD_N |

In Step 306, according to the matching information table TBE and the command CMD, the adaptor unit 202_x forwards the command CMD to the virtual target vTGT_y, and the SDS system 20 performs operations on the virtual target vTGT_y. Specifically, in an embodiment, when the virtual target vTGT_y has only one replica and the matching information table TBE is formed as TABLE I, the adaptor units 202_1-202_N compares the command CMD with the SCSI column of the table TBE, if the adaptor unit 202_x finds that the command CMD and the virtual target vTGT_y are corresponding to the adaptor unit 202_x itself, then the adaptor unit 202_x forwards the command CMD to the virtual target vTGT_y, and the rest of the adaptor units have no action. In an embodiment, when the virtual target vTGT_y has the replicas vTGT_y_1-vTGT_y_K and the matching information table TBE is formed as TABLE II, if the adaptor unit 202_x finds that the command CMD and the optimum replica vTGT_y_opt are corresponding to the adaptor unit 202_x itself, then the adaptor unit 202_x forwards the command CMD to the optimum replica vTGT_y_opt, and the rest of the adaptor units have no action. Therefore, the SDS system 20 may perform on target information via the optimum replica vTGT_y_opt.

As can be seen from the above, by storage process 30, computation of path selection are centralized and executed by the control unit 204. After the control unit 204 completes the computation, the control unit 204 sends the computational results of path selection in the form of the matching information table TBE to the adaptor units 202_1-202_N. The adaptor units 202_1-202_N may forward the command CMD to the virtual target or the optimum replica. Compared to the prior art, the adaptor units 202_1-202_N do not execute computation of path selection, instead, the adaptor units 202_1-202_N only receive the results computed by the control unit 204 and forward the command CMD to the corresponding virtual target. Therefore, the adaptor units 202_1-202_N may be implemented by cheap storage interface cards, so as to reduce the production cost of the SDS system 20.

Notably, the embodiments stated in the above are utilized for illustrating concepts of the present invention. Those skilled in the art may make modifications and alternations accordingly, and not limited herein. For example, the control unit 204 is not limited to be implemented by hardware equipment such as computer, server, etc. The control unit 204 may also be implemented by software such as virtual machine (VM). The virtual targets and the replicas are not limited to be implemented by software. The virtual targets and the replicas may also be implemented by firmware. In addition, in Step 304, the method of selecting the optimum replica with the shortest response time among a plurality of replicas is not limited by using the ACO algorithm. Other path selection algorithms may also be used to realize the computation of path selection. As long as the computation of path selection is centralized and executed by one single control unit of the SDS system, the requirement of the present invention is satisfied.

In summary, the present invention centralizes the computation of path selection on one single control unit; the adaptor units do not execute computation of path selection. Thus, the adaptor units may be implemented by cheap storage interface cards. Compared with the prior art, the storage method and system may effectively reduce the production cost of the SDS system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A storage method utilized in a software defined storage (SDS) system, the SDS system comprising a load balancer, a control unit and a plurality of adaptor units, the plurality of adaptor units corresponding to a plurality of virtual targets, the storage method comprising:
the load balancer sending a command to the plurality of adaptor units after the SDS system receives the command;
the control unit generating a matching information according to characteristics of the plurality of virtual targets, and sending the matching information to the plurality of adaptor units; and
a first adaptor unit of the plurality of adaptor units forwarding the command to the first virtual target according to the matching information and the command, and the SDS system performing operation on a first virtual target.

2. The storage method of claim 1, wherein each virtual target of the plurality of virtual targets forms at least a replica of the each virtual target.

3. The storage method of claim 2, wherein a number of the at least a replica is increased or decreased according to system requirements.

4. The storage method of claim 2, wherein the plurality of virtual target and the at least a replica are implemented via software or firmware.

5. The storage method of claim 2, wherein the step of the control unit generating the matching information according to the plurality of virtual targets further comprises:
when a number of replicas formed by the first virtue target is greater than 1, the control unit selecting an optimum replica among a plurality of first replicas corresponding to the first virtue target according to the plurality of adaptor units and the plurality of first replicas; and
the control unit generating the matching information according to the plurality of adaptor units and the optimum replica.

6. The storage method of claim 4, wherein the control unit selects the optimum replica among the plurality of first replicas by an ant colony optimal (ACO) algorithm.

7. The storage method of claim 1, wherein the command is a small computer system interface (SCSI) command.

8. The storage method of claim 1, wherein the load balancer, the control unit, and the plurality of adaptor units are implemented via hardware or software.

9. The storage method of claim 1, wherein the characteristics of the plurality of virtual targets is response times of the plurality of virtual targets.

10. A software defined storage system, comprising:
a plurality of adaptor units corresponding to a plurality of virtual targets;
a load balancer configured to send a command to the plurality of adaptor units; and
a control unit configured to generate a matching information according to characteristics of the plurality of virtual targets, and send the matching information to the plurality of adaptor units;
wherein a first adaptor unit of the plurality of adaptor units forwards the command to the first virtual target according to the matching information and the command, and the SDS system performs operation on a first virtual target.

11. The software defined storage system of claim 10, wherein each virtual target of the plurality of virtual targets forms at least a replica of the each virtual target.

12. The software defined storage system of claim 11, wherein a number of the at least a replica is increased or decreased according to system requirements.

13. The software defined storage system of claim 11, wherein the control unit is further configured to perform the following steps to generate the matching information according to the plurality of virtual targets:
when a number of replicas formed by the first virtue target is greater than 1, the control unit selects an optimum replica among a plurality of first replicas corresponding to the first virtue target according to the plurality of adaptor units and the plurality of first replicas; and
the control unit generates the matching information according to the plurality of adaptor units and the optimum replica.

14. The software defined storage system of claim 13, wherein the control unit is further configured to select the optimum replica among the plurality of first replicas by an ant colony optimal (ACO) algorithm.

15. The software defined storage system of claim 10, wherein the command is a small computer system interface (SCSI) command.

16. The software defined storage system of claim 10, wherein the load balancer, the control unit, and the plurality of adaptor units are implemented via hardware or software.

17. The software defined storage system of claim 10, wherein the plurality of virtual targets and the at least a replica are implemented via software or firmware.

18. The software defined storage system of claim 10, wherein the characteristics of the plurality of virtual targets is response times of the plurality of virtual targets.
